(19) United States
(12) Patent Application Publication
(10) Pub. No.: US 2025/0147503 A1
(43) Pub. Date: May 8, 2025

(54) EQUIPMENT FAILURE MODE PREDETERMINATION AND RESIDUAL LIFE PREDICTION COUPLING SYSTEM AND METHOD

(71) Applicant: CHENGDU UNIVERSITY OF TECHNOLOGY, CHENGDU (CN)

(72) Inventors: HUYANG XU, CHENGDU (CN); YONG ZHANG, NANYANG (CN); CHUNCAN YIN, CHENGDU (CN); XIAOGUANG WANG, CHENGDU (CN); ZHENJIE SUN, CHENGDU (CN)

(21) Appl. No.: 18/934,872

(22) Filed: Nov. 1, 2024

(30) Foreign Application Priority Data
Nov. 7, 2023 (CN) 202311467012.0

(51) Int. Cl. G05B 23/02

(52) U.S. Cl. CPC G05B 23/0283; G05B 23/0243

(57) ABSTRACT

Disclosed are an equipment failure mode predetermination and residual life prediction coupling system and method. The equipment failure mode predetermination and residual life prediction coupling system realizes coupling of equipment failure mode predetermination and residual life prediction, continuous collection of health information of equipment, predetermination of the failure mode and prediction of the residual life based on the state of health of the equipment in operation monitored and perceived in real time by sensor sets.

### BACKGROUND OF THE INVENTION

### 1. Technical Field

The invention belongs to the technical field of failure prediction, and particularly relates to an equipment failure mode predetermination and residual life prediction coupling system and method.

### 2. Description of Related Art

Under the background of the Internet of Things (JoT), the addition of an intelligent data acquisition terminal to equipment to realize digital perception of the state of health of the equipment and the construction of an intelligent equipment failure prediction and health management system on this basis have been increasingly preferred by enterprises using the equipment.

The key task of failure prediction and health management is to predict the residual life. In practice, collected equipment monitoring data often has the features of uncertainty in initial state and discrepancy in value density. Wherein, the uncertainty in initial state means that the uncertainty in equipment maintenance effect will be reflected by equipment monitoring data, and the discrepancy in value density means that monitoring data collected at a moment closer to a failure of equipment in operation has higher value in residual life prediction.

In practice, a large amount of monitoring data will be generated during continuous monitoring of equipment. With the development of technology, the probability of equipment failures becomes lower, and the interval between two adjacent equipment failures becomes longer. Limited by storage or transmission media, it is necessary for the failure prediction and health management system to continuously wipe and cover outdated monitoring data with new monitoring data to maintain normal operation of an equipment monitoring system and the reasonability of equipment monitoring costs.

In addition, an equipment maintenance network formed by multiple pieces of equipment, such as an oil-gas equipment maintenance network, a wind power equipment maintenance network or road network equipment maintenance network, generally has outstanding geographical spatial dispersion. Considering multiple failure modes caused by the complexity of equipment, the spatial discreteness and time randomness of equipment failures are superposed, making it necessary to determine the equipment failure mode while the residual life is predicted. The coupling of equipment failure mode predetermination and residual life prediction can optimize the scheduling of equipment maintenance activities, improve the equipment maintenance resource management capacity and the overall maintenance efficiency of equipment groups, and reduce equipment maintenance management costs.

### BRIEF SUMMARY OF THE INVENTION

To solve the above problems, the invention provides an equipment failure mode predetermination and residual life prediction coupling system and method.

The technical solution of the invention is as follows: an equipment failure mode predetermination and residual life prediction coupling system comprises an equipment maintenance network and an equipment maintenance decision-making platform which are in communication connection with each other, wherein the equipment maintenance network is used for determining a failure mode and predicting a residual life, and the equipment maintenance decision-making platform is used for receiving the failure mode and residual life of equipment and transmitting the failure mode and residual life of the equipment to operation and maintenance staff.

The equipment maintenance network comprises equipment nodes, sensor sets, abnormal state recognition modules and an equipment failure mode predetermination and residual life prediction coupling module;
each of the sensor sets comprises a plurality of sensors used for acquiring equipment health information of the corresponding equipment node;
each of the abnormal state recognition modules is used for receiving and caching the equipment health information and recognizing a time of occurrence of an exception of equipment to be detected;
the equipment failure mode predetermination and residual life prediction coupling module is used for determining the failure mode and predicting the residual life according to the time of occurrence of the exception, and transmitting the failure mode and the residual life to the equipment maintenance decision-making platform.

The invention has the following beneficial effects: the equipment failure mode predetermination and residual life prediction coupling system realizes coupling of equipment failure mode predetermination and residual life prediction based on the state of health of equipment in operation monitored and perceived in real time by the sensor sets; the sensor sets are located in the equipment nodes and continuously collect health information of the equipment; the abnormal state recognition modules are located in the equipment nodes, cache a multivariate temporal data flow and recognize the time of occurrence of the exception of the equipment; and the equipment failure mode predetermination and residual life prediction coupling module predetermines the failure mode and predicts the residual life.

Based on the equipment failure mode predetermination and residual life prediction coupling system, the invention further provides an equipment failure mode predetermination and residual life prediction coupling method, comprising the following steps:
S1: acquiring, by sensors, equipment health information of equipment to be detected;
S2: receiving and caching the equipment health information and recognizing a time of occurrence of an exception of the equipment to be detected, by an abnormal state recognition module;
S3: according to the time of occurrence of the exception of the equipment to be detected, determining a failure mode and predicting a residual life by an equipment failure mode predetermination and residual life prediction coupling module; and
S4: transmitting the failure mode and the residual life to an equipment maintenance decision-making platform.

Further, in S1, equipment health information at a time t comprises equipment operation environment information and equipment operation state information;
wherein, the equipment health information x(t) at the time t is expressed as x(t)={A₁(t), A₂(t), . . . , Aᵥ_{ₚ}(t), B₁(t), B₂(t), . . . , Bᵤ_{ₚ}(t)}, the equipment operation environment information at the time t is expressed as {A₁(t), A₂(t), . . . , Aᵥ_{ₚ}(t),}, and the equipment operation state information at the time t is expressed as {B₁(t), B₂(t), . . . , Bᵤ_{ₚ}(t)};
where, vₚ denotes the number of monitored operation environment variables corresponding to an equipment type p, uₚ denotes the number of monitored operation state variables of the equipment type p, A₁(t), A₂(t), . . . Aᵥ_{ₚ}(t) denote operation environment variables corresponding to each equipment type monitored at the time t, and B₁(t), B₂(t), . . . , Bᵤ_{ₚ}(t) denote operation states variables corresponding to each equipment type monitored at the time t.

Further, S2 comprises the following sub-steps:
S21: receiving and catching, by the abnormal state recognition module, equipment health information at a time t;
S22: according to the equipment health information at the time t, predicting, by an ARIMA prediction model, predictive equipment health information at a time t+1 and prediction intervals; and
S23: according to the predictive equipment health information at the time t+1 and the prediction intervals, determining the time of occurrence of the exception.

Further, in S22, the predictive equipment health information \hat{x}(t+1) at the time t+1 is expressed as \hat{x}(t+1)={Â₁(t+1), Â₂(t+1), . . . , Âᵥ_{ₚ}(t+1), \hat{B}₁(t+1), \hat{B}₂(t+1), . . . , \hat{B}ᵤ_{ₚ}(t+1)}, a prediction interval of equipment operation environment information is expressed as [Âᵥ^{L}(t+1), Âᵥ^{U}(t+1)], v∈{1, 2, . . . , vₚ], and a prediction interval of equipment operation state information is expressed as [\hat{B}ᵤ^{L}(t+1), \hat{B}ᵤ^{U}(t+1)],u∈{1, 2, . . . , uₚ];
where, Â₁(t+1), Â₂(t+1), . . . , Âᵥ_{ₚ}(t+1) denote predicted values of operation environment variables corresponding to each equipment type monitored at the time t+1, \hat{B}₁(t+1), \hat{B}₂(t+1), . . . , \hat{B}ᵤ_{ₚ}(t+1) denote predicted values of operation state variables corresponding to each equipment type monitored at the time t+1, Âᵥ^{L}(t+1) denotes a lower limit of a prediction interval of a v^{th} operation environment variable corresponding to each equipment type monitored at the time t+1, Âᵤ^{U}(t+1) denotes an upper limit of the prediction interval of the v^{th} operation environment variable corresponding to each equipment type monitored at the time t+1, \hat{B}ᵤ^{L}(t+1) denotes a lower limit of a prediction interval of a u^{th} operation state variable corresponding to each equipment type monitored at the time t+1, \hat{B}ᵤ^{U}(t+1) denotes an upper limit of the prediction interval of the u^{th} operation state variable corresponding to each equipment type monitored at the time t+1, uₚ denotes the number of monitored operation state variables of an equipment type p, L denotes a preset lower warning limit, and U denotes a preset upper warning limit.

Further, in S23, if Aᵥ(t+1) is not within a prediction interval [Âᵥ^{L}(t+1), Âᵥ^{U}(t+1)] of the equipment operation environment information, an equipment operation environment at the time t+1 is abnormal;
if Bᵤ(t+1) is not within a prediction interval [\hat{B}ᵤ^{L}(t+1), \hat{B}ᵤ^{U}(t+1)] of the equipment operation state information, an equipment operation state at the time t+1 is abnormal;
where, Aᵥ(t+1) denotes an actual observed value of a v^{th} operation environment variable corresponding to each equipment type monitored at the time t+1, Bᵤ(t+1) an actual observed value of a u^{th} operation state variable corresponding to each equipment type monitored at the time t+1, Âᵥ^{L}(t+1) denotes a lower limit of a prediction interval of the v^{th} operation environment variable corresponding to each equipment type monitored at the time t+1, Âᵥ^{U}(t+1) denotes an upper limit of the prediction interval of the v^{th} operation environment variable corresponding to each equipment type monitored at the time t+1, \hat{B}ᵤ^{L}(t+1) denotes a lower limit of a prediction interval of the u^{th} operation state variable corresponding to each equipment type monitored at the time t+1, and \hat{B}ᵤ^{U}(t+1) denotes an upper limit of the prediction interval of the u^{th} operation state variable corresponding to each equipment type monitored at the time t+1.

Further, S3 comprises the following sub-steps:
S31: extracting, a temporal sample, of the equipment failure mode predetermination and residual life prediction coupling module;
S32: calculating, by a probabilistic graphical model, a cumulative failure occurrence probability of the temporal sample;
S33: according to the cumulative failure occurrence probability of the temporal sample, calculating an empirical distribution function of each probabilistic graphical model fragment, and taking a time and failure mode corresponding to a maximum value of the empirical distribution function as an equipment residual life predicted value and a failure mode predicted value respectively;
S34: determining, by a DKW inequation, a confidence interval of the equipment residual life predicted value, and calculating, by an edge density function, a variance of the failure mode predicted value; and
S35: taking the equipment residual life predicted value, the failure mode predicted value, the confidence interval of the equipment residual life predicted value and the variance of the failure mode predicted value as prediction results of the equipment failure mode predetermination and residual life prediction coupling module.

Further, in S31, the temporal sample x_{pq} is expressed as x_{pq}={x_{pq}(1), . . . , x_{pq}(T_{gq}^{c}−1), x_{pq}(T_{gq}^{c})};
where, x_{pq}(1), . . . , x_{pq}(T_{gq}^{c}−1), x_{pq}(T_{pq}^{c}) denote health information fragments of T_{pq}^{c} equipment nodes q of the equipment type p periodically collected at a time Tₚ^{c}.

Further, in S32, a specific method for calculating the cumulative failure occurrence probability of the temporal sample comprises: moving rightwards, by the probabilistic graphical model, the probabilistic graphical model fragment corresponding to each element in a probabilistic graphical model set by one time slice, calculating a distance from a right end of each probabilistic graphical model fragment to a right end of the corresponding element and an accumulative occurrence probability of each failure mode until the distance from the right end of each probabilistic graphical model fragment to the right end of the corresponding element is zero, and determining the accumulative failure occurrence probability;
wherein, the probabilistic graphical model set is expressed as {Gₚ₁, Gₚ₂, . . . , G_{pK}_{ₚ}}, where Gₚ₁, Gp₂, . . . , G_{pK}_{ₚ} denote probabilistic graphical models corresponding to Kₚ failure modes of the equipment type p;
the accumulative occurrence probability F(lₚₖ,k|x_{pq}) of each failure mode is calculated by:

$$F ( {l}_{pk} , k \vert {x}_{pq} ) = Pr ( RUL < {l}_{pk} , k , {x}_{pq} ) / Pr ( {x}_{pq} )$$

where, lₚₖ denotes the distance from the right end of each probabilistic graphical model fragment to the right end of the corresponding element, x_{pq} denotes the temporal sample, RUL denotes the residual life, Pr(⋅) denotes a probability function, and k denotes each failure mode of the equipment type p.

Further, in S33, the empirical distribution function Pr(RUL=lₚₖ,k|x_{pq}) of each probabilistic graphical model fragment is expressed as:

$$\begin{matrix}Pr ( RUL = {l}_{pk} , k \vert {x}_{pq} ) = F ( {l}_{pk} + 1 , k \vert {x}_{pq} ) - F ( {l}_{pk} , k \vert {x}_{pq} ) , {l}_{pk} \\ = - {T}_{p} + {T}_{p}^{c} - 1 , - {T}_{p} + {T}_{p}^{c} , … , 0\end{matrix}$$

where, lₚₖ denotes the distance from the right end of each probabilistic graphical model fragment to the right end of the corresponding element, x_{pq} denotes the temporal sample, RUL denotes the residual life, Pr(⋅) denotes the probability function, k denotes each failure mode of the equipment type p, F(⋅) denotes the probability function, T_{P} denotes the number of time slices in the probabilistic graphical model, and Tₚ^{c} denotes a periodical extraction time.

The invention has the following beneficial effects: the equipment failure mode predetermination and residual life prediction coupling method can provide a failure mode predetermination result and a residual life prediction result at the same time; in the scenario of an equipment maintenance network, the situation where only the residual life is predicted and the failure mode is not predetermined is avoided; the intelligent level of predictive maintenance of equipment can be improved; and a basic condition for simplifying maintenance activities, improving maintenance efficiency and reducing maintenance costs in the scene of the equipment maintenance network can be provided.

### BRIEF DESCRIPTION OF THE SEVERAL VIEWS OF THE DRAWINGS

FIG. 1 is a structural diagram of an equipment failure mode predetermination and residual life coupling system;

FIG. 2 is a flow diagram of an equipment failure mode predetermination and residual life coupling method;

FIG. 3 is a schematic diagram of probabilistic graphical models of failure modes of equipment types.

### DETAILED DESCRIPTION OF THE INVENTION

The embodiments of the invention are further described below in conjunction with accompanying drawings.

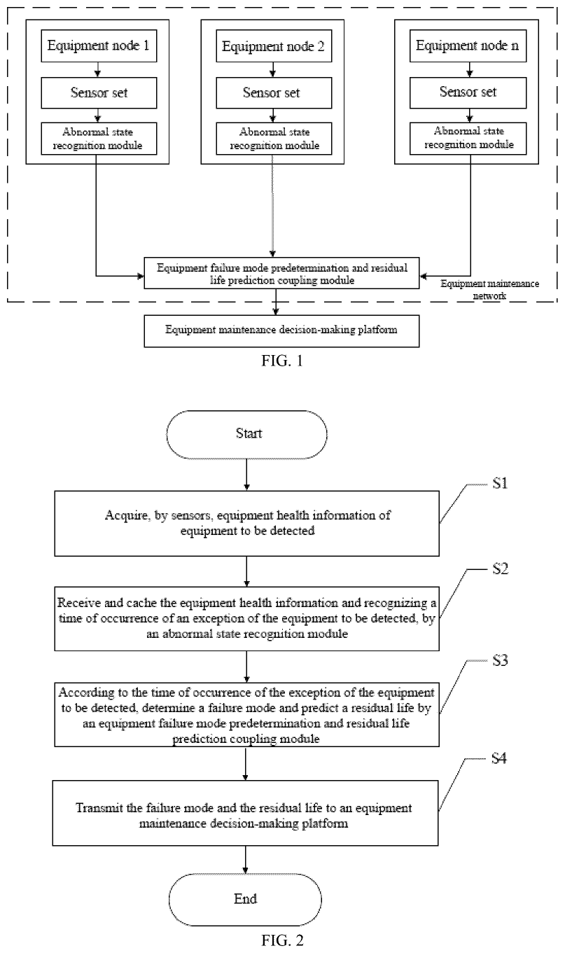

As shown in FIG. 1, the invention provides an equipment failure mode predetermination and residual life prediction coupling system, comprising an equipment maintenance network and an equipment maintenance decision-making platform which are in communication connection with each other, wherein the equipment maintenance network is used for determining a failure mode and predicting a residual life, and the equipment maintenance decision-making platform is used for receiving the failure mode and residual life of equipment and transmitting the failure mode and residual life of the equipment to operation and maintenance staff; the operation and maintenance staff can manage equipment maintenance activities and equipment maintenance resources, wherein the equipment maintenance activities involve localization of a failure position, determination of failure causes, making of a maintenance strategy, implementation of the maintenance strategy, and an overall description of the types of failures, maintenance positions, maintenance methods and desired maintenance effects in all links of an equipment maintenance activity; and the equipment maintenance resources involve various resources for guaranteeing normal operation of equipment and prolonging the service life of equipment and resources possessed and managed by equipment manufacturers or enterprises using equipment, including labor resources, materials, knowledge and tools.

The equipment maintenance network comprises equipment nodes, sensor sets, abnormal state recognition modules and an equipment failure mode predetermination and residual life prediction coupling module;
each of the sensor sets comprises a plurality of sensors used for acquiring equipment health information of the corresponding equipment node;
each of the abnormal state recognition module is used for receiving and caching the equipment health information and recognizing a time of occurrence of an exception of equipment to be detected;
the equipment failure mode predetermination and residual life prediction coupling module is used for determining the failure mode and predicting the residual life according to the time of occurrence of the exception, and transmitting the failure mode and the residual life to the equipment maintenance decision-making platform.

The equipment node refers to a piece of equipment. In an equipment maintenance network, each piece of equipment is equipped with a plurality of sensors which form a sensor set, and each equipment is equipped with an abnormal state recognition module.

Equipment health information is monitored continuously to form a multivariate temporal data flow. The abnormal state recognition module caches the multivariate temporal data flow. When cached, the length of multivariate temporal data will not change with time and is a constant. Outdated data is covered with new data based on the first-in/first-out principle.

Based on the equipment failure mode predetermination and residual life prediction coupling system, the invention further provides an equipment failure mode predetermination and residual life prediction coupling method. As shown in FIG. 2, the equipment failure mode predetermination and residual life prediction coupling method comprises the following steps:
S1: acquiring, by sensors, equipment health information of equipment to be detected;
S2: receiving and caching the equipment health information and recognizing a time of occurrence of an exception of the equipment to be detected, by an abnormal state recognition module;
S3: according to the time of occurrence of the exception of the equipment to be detected, predetermining a failure mode and predicting a residual life by an equipment failure mode predetermination and residual life prediction coupling module; and
S4: transmitting the failure mode and the residual life to an equipment maintenance decision-making platform.

In one embodiment of the invention, in S1, equipment health information at a time t comprises equipment operation environment information and equipment operation state information;
where, the equipment health information x(t) at the time t is expressed as x(t)={A₁(t), A₂(t), . . . , Aᵥ_{ₚ}(t), B₁(t), B₂(t), . . . , Bᵤ_{ₚ}(t)}, the equipment operation environment information at the time t is expressed as {A₁(t), A₂(t), . . . Aᵥ_{ₚ}(t)}, and the equipment operation state information at the time t is expressed as {B₁(t), B₂(t), . . . , Bᵤ_{ₚ}(t)};
where, vₚ denotes the number of monitored operation environment variables corresponding to an equipment type p, uₚ denotes the number of monitored operation state variables of the equipment type p, A₁(t), A₂(t), . . . Aᵥ_{ₚ}(t) denote operation environment variables corresponding to each equipment type monitored at the time t, and B₁(t), B₂(t), . . . , Bᵤ_{ₚ}(t) denote operation states variables corresponding to each equipment type monitored at the time t.

In one embodiment of the invention, S2 comprises the following sub-steps:
S21: receiving and catching, by the abnormal state recognition module, equipment health information at a time t, wherein for an equipment type p, the length of multivariate temporal data cached in the abnormal state recognition module is nₚ;
S22: according to the equipment health information at the time t, predicting, by an ARIMA prediction model, predictive equipment health information at a time t+1 and prediction intervals; and
S23: according to the predictive equipment health information at the time t+1 and the prediction intervals, determining the time of occurrence of the exception.

In S2, whether the predictive data information exceeds a set threshold is determined; if the predictive data information exceeds the set threshold, the multivariate temporal data is uploaded to the equipment failure mode predetermination and residual life prediction coupling module; if the predictive data information does not exceed the set threshold, equipment health state information is continuously collected. The abnormal state recognition module sends the type of the exception, the name of a monitored variable causing the exception, and the time of occurrence of the exception to the equipment failure mode predetermination and residual life prediction coupling module, and after obtaining a failure mode predetermination result and a residual life prediction result, the abnormal information will be sent to the remote equipment maintenance decision-making platform to support scheduling of equipment maintenance activities and management of equipment maintenance resources. A failure will lead to an alarm or a shutdown of equipment, and the exception does not comprise the failure.

A differential autoregressive integrated moving average (ARIMA) model, also referred to as an autoregressive integrated moving average model (moving may also be referred to as sliding) is one of time series prediction and analysis methods.

In one embodiment of the invention, in S22, the predictive equipment health information \hat{x}(t+1) at the time t+1 is expressed as \hat{x}(t+1)={Â₁(t+1), Â₂(t+1), . . . , Âᵥ_{ₚ}(t+1), \hat{B}₁(t+1), \hat{B}₂(t+1), . . . , \hat{B}ᵤ_{ₚ}(t+1)}, a prediction interval of equipment operation environment information is expressed as [Âᵥ^{L}(t+1), Âᵥ^{U}(t+1)], v∈{1, 2, . . . , vₚ], and a prediction interval of equipment operation state information is expressed as [\hat{B}ᵤ^{L}(t+1), \hat{B}ᵤ^{U}(t+1)], u∈{1, 2, . . . , uₚ];
where, Â₁(t+1), Â₂(t+1), . . . , Âᵥ_{ₚ}(t+1) denote predicted values of operation environment variables corresponding to each equipment type monitored at the time t+1, \hat{B}₁(t+1), \hat{B}₂(t+1), . . . , \hat{B}ᵤ_{ₚ}(t+1) denote predicted values of operation state variables corresponding to each equipment type monitored at the time t+1, Âᵥ^{L}(t+1) denotes a lower limit of a prediction interval of a v^{th} operation environment variable corresponding to each equipment type monitored at the time t+1, Âᵥ^{L}(t+1) denotes an upper limit of the prediction interval of the v^{th} operation environment variable corresponding to each equipment type monitored at the time t+1, \hat{B}ᵤ^{L}(t+1) denotes a lower limit of a prediction interval of a u^{th} operation state variable corresponding to each equipment type monitored at the time t+1, \hat{B}ᵤ^{U}(t+1) denotes an upper limit of the prediction interval of the u^{th} operation state variable corresponding to each equipment type monitored at the time t+1, uₚ denotes the number of monitored operation state variables of an equipment type p, L denotes a preset lower warning limit, and U denotes a preset upper warning limit.

In one embodiment of the invention, in S23, if Aᵥ(t+1) is not within a prediction interval [Âᵥ^{L}(t+1), Âᵥ^{U}(t+1)] of the equipment operation environment information, an equipment operation environment at the time t+1 is abnormal;
if Bᵤ(t+1) is not within a prediction interval [\hat{B}ᵤ^{L}(t+1), \hat{B}ᵤ^{U}(t+1)] of the equipment operation state information, an equipment operation state at the time t+1 is abnormal;
where, Aᵥ(t+1) denotes an actual observed value of a v^{th} operation environment variable corresponding to each equipment type monitored at the time t+1, Bᵤ(t+1) an actual observed value of a u^{th} operation state variable corresponding to each equipment type monitored at the time t+1, Âᵥ^{L}(t+1) denotes a lower limit of a prediction interval of the v^{th} operation environment variable corresponding to each equipment type monitored at the time t+1, Âᵥ^{L}(t+1) denotes an upper limit of the prediction interval of the v^{th} operation environment variable corresponding to each equipment type monitored at the time t+1, \hat{B}ᵤ^{L}(t+1) denotes a lower limit of a prediction interval of the u^{th} operation state variable corresponding to each equipment type monitored at the time t+1, and \hat{B}ᵤ^{U}(t+1) denotes an upper limit of the prediction interval of the u^{th} operation state variable corresponding to each equipment type monitored at the time t+1.

In one embodiment of the invention, S3 comprises the following sub-steps:
S31: extracting, a temporal sample, of the equipment failure mode predetermination and residual life prediction coupling module;
S32: calculating, by a probabilistic graphical model, a cumulative failure occurrence probability of the temporal sample;
S33: according to the cumulative failure occurrence probability of the temporal sample, calculating an empirical distribution function of each probabilistic graphical model fragment, and taking a time and failure mode corresponding to a maximum value of the empirical distribution function as an equipment residual life predicted value and a failure mode predicted value respectively;
S34: determining, by a DKW inequation, a confidence interval of the equipment residual life predicted value, and calculating, by an edge density function, a variance of the failure mode predicted value; and
S35: taking the equipment residual life predicted value, the failure mode predicted value, the confidence interval of the equipment residual life predicted value and the variance of the failure mode predicted value as prediction results of the equipment failure mode predetermination and residual life prediction coupling module.

The probabilistic graphical model is a theory for expressing the probabilistic dependency relationship of variables with a graph and indicates the joint probability distribution of the variables related to a model in conjunction with the probability theory and the graph theory.

The DKW inequation is a method for estimating limits of differences between an empirical distribution theoretical function and sample distributions in the probability and statistics theory.

In one embodiment of the invention, in S31, the temporal sample x_{pq} is expressed as x_{pq}={x_{pq}(1), . . . , x_{pq}(T_{gq}^{c}−1), x_{pq}(T_{pq}^{c})};
where, x_{pq}(1), . . . , x_{pq}(T_{pq}^{c}−1), x_{pq}(T_{pq}^{c}) denote health information fragments of T_{pq}^{c} equipment nodes q of the equipment type p periodically collected at a time Tₚ^{c};

In one embodiment of the invention, in S32, a specific method for calculating the cumulative failure occurrence probability of the temporal sample comprises: moving rightwards, by the probabilistic graphical model, the probabilistic graphical model fragment corresponding to each element in a probabilistic graphical model set by one time slice, calculating a distance from a right end of each probabilistic graphical model fragment to a right end of the corresponding element and an accumulative occurrence probability of each failure mode until the distances from the right end of each probabilistic graphical model fragment to the right end of the corresponding element is zero, and determining the accumulative failure occurrence probability;
wherein, the probabilistic graphical model set is expressed as {Gₚ₁, Gₚ₂, . . . , G_{pK}_{ₚ}}, where Gₚ₁, Gₚ₂, . . . , G_{pK}_{ₚ}, denote probabilistic graphical models corresponding to Kₚ failure modes of the equipment type p;
the accumulative occurrence probability F(lₚₖ,k|x_{pq}) of each failure mode is calculated by:

$$F ( {l}_{pk} , k \vert {x}_{pq} ) = Pr ( RUL < {l}_{pk} , k , {x}_{pq} ) / Pr ( {x}_{pq} )$$

where, lₚₖ denotes the distance from the right end of each probabilistic graphical model fragment to the right end of the corresponding element, x_{pq} denotes the temporal sample, RUL denotes the residual life, Pr(⋅) denotes a probability function, and k denotes each failure mode of the equipment type p;

For each failure mode k=1, 2, . . . , Kₚ of the equipment type p, the cumulative occurrence probability of the failure mode is calculated. The probabilistic graphical model fragment extracted by each element in the probabilistic graphical model set is moved rightward by one time slice, assume the temporal sample x_{pq} is observed in one fragment, the distance lₚₖ² from the right end of the fragment to the right end of Gₚₖ is recorded, and the accumulative occurrence probability of each failure mode is calculated. For example, the accumulative occurrence probability of the failure mode k of the equipment type p is F(lₚₖ²,k|x_{pq})=Pr(RUL<lₚₖ²,k,x_{pq})/Pr(x_{pq}). In this way, every time the probabilistic graphical model fragment extracted by each element in the probabilistic graphical model set is moved rightward by one time slice, the distance from the right end of each model fragment to the right end of the corresponding distance is recorded, and the accumulative occurrence probability of each failure mode is calculated until the right end of each model fragment coincides with the right end of the corresponding element. By means of this process, the cumulative probability of x_{pq} in each failure mode k of the equipment type p is calculated.

In one embodiment of the invention, in S33, the empirical distribution function Pr(RUL=lₚₖ,k|x_{pq}) of each probabilistic graphical model fragment is expressed as:

$$\begin{matrix}Pr ( RUL = {l}_{pk} , k \vert {x}_{pq} ) = F ( {l}_{pk} + 1 , k \vert {x}_{pq} ) - F ( {l}_{pk} , k \vert {x}_{pq} ) , {l}_{pk} \\ = - {T}_{p} + {T}_{p}^{c} - 1 , - {T}_{p} + {T}_{p}^{c} , … , 0\end{matrix}$$

where, lₚₖ denotes the distance from the right end of each probabilistic graphical model fragment to the right end of the corresponding element, x_{pq} denotes the temporal sample, RUL denotes the residual life, Pr(⋅) denotes the probability function, k denotes each failure mode of the equipment type p, F(⋅) denotes the probability function, T_{P} denotes the number of time slices in the probabilistic graphical model, and Tₚ^{c} denotes a periodical extraction time.

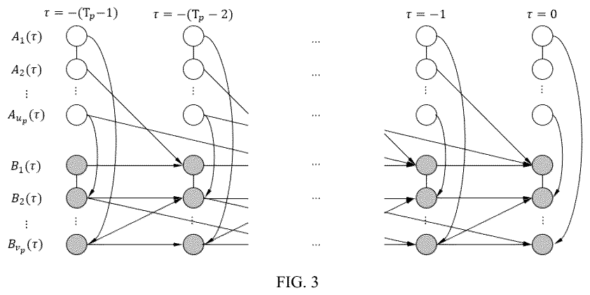

The number Tₚ of time slices in the probabilistic graphical model Gₚₖ is Tₚ. Each time slice includes all monitored variables of the equipment type p. As shown in FIG. 3, for any time slice τ∈{1, 2, . . . , Tₚ}, X(τ)={A₁(τ), A₂(τ), . . . , Aᵥ_{ₚ}(τ), B₁(τ), B₂(τ), . . . , Bᵤ_{ₚ}(τ)}. All the time slices of Gₚₖ form an equipment degradation process node set of the failure modes k of the equipment type p. The node X(τ) indicates the value of each monitored variable at a time τ.

The probabilistic graphical model Gₚₖ can reflect the conditional independence of monitored variables. That is, when two monitored variables are selected and the relations between the two monitored variables and other monitored variables are given, if there is no connecting line between the two monitored variables, it is determined that the two monitored variables are conditionally independent.

An edge set of the probabilistic graphical model Gₚₖ includes undirected edges and directed edges. Wherein, the undirected edge is used for depicting the relation between the same type of monitored variables in the time slice, and the directed edge is used for depicting the relation between the monitored variables between time slices and the relation between different types of monitored variables in the time slice.

The edge set of the probabilistic graphical model Gₚₖ follows the two constraints: first, there is no connecting line between monitored operation environment variables; second, the directed edge points from an earlier time slice to a later time slice or points from a monitored operation environment variable to a monitored operation state variable.

The probabilistic graphical model Gₚₖ includes three types of parameters: first, an edge probability distribution function defined for nodes without parent nodes; a conditional probability distribution function defined for nodes with parent nodes under a parent node variable; third, a covariance matrix defined for nodes connected by undirected edges in each time slice. The structure and parameters of the probabilistic graphical model Gₚₖ jointly define the variation with time of the relation between the equipment degradation process of the failure modes k of the equipment type p and the monitored variables.

Each time slice of the probabilistic graphical model Gₚₖ indicates the residual life with a time period as the unit. That is, the last time slice of the probabilistic graphical model indicates the occurrence of an equipment failure, the second last time slice of the probabilistic graphical model indicates that there is still one time period to the equipment failure, and by analogue, the leftmost time slice of the probabilistic graphical model indicates the longest life cycle of an observed value.

The number of equipment nodes in the equipment maintenance network is Q. When an exception happens to the equipment node q∈{1, 2, . . . , Q}, the equipment node will continuously transmit multivariant temporal data to an aggregation node. The aggregation node recognizes the equipment type p of the abnormal equipment node and sets the time of occurrence of the exception to 0. Considering that the equipment type of the equipment node q is p, when T>0, multivariant temporal data of the abnormal equipment node q stored in the aggregation node is x_{pq}={x_{pq}(1), . . . , x_{pq}(T−1),x_{pq}(T)}. Because the abnormal equipment node q will continuously transmit multivariant temporal data to the aggregation node, the value of the variable T will increase continuously. If T≥Tₚ, the failure mode predetermination and residual life prediction coupling module stops working, wherein Tₚ is the number of all the time slices of Gₚₖ.

For the equipment node q₁∈{1, 2, . . . , Q} and the equipment node q₂∈{1, 2, . . . , Q}, if the equipment type of q₁ is the same as the equipment type of q₂, when an exception happens to q₁ or q₂, the failure mode predetermination and residual life prediction coupling process is the same.

Those ordinarily skilled in the art should understand that the embodiments are provided here to help readers understand the principle of the invention, and the protection scope of the invention should not be limited to such special statements and embodiments. Those ordinarily skilled in the art can make various specific transformations and combinations according to the technical enlightenment disclosed here without departing from the essence of the invention, and all these transformations and combinations should still fall within the protection scope of the invention.

What is claimed is:

1. An equipment failure mode predetermination and residual life prediction coupling system, comprising an equipment maintenance network and an equipment maintenance decision-making platform which are in communication connection with each other, wherein the equipment maintenance network is used for determining a failure mode and predicting a residual life, and the equipment maintenance decision-making platform is used for receiving the failure mode and residual life of equipment and transmitting the failure mode and residual life of the equipment to operation and maintenance staff;
the equipment maintenance network comprises equipment nodes, sensor sets, abnormal state recognition modules and an equipment failure mode predetermination and residual life prediction coupling module;
each of the sensor sets comprises a plurality of sensors used for acquiring equipment health information of the corresponding equipment node;
each of the abnormal state recognition modules is used for receiving and caching the equipment health information and recognizing a time of occurrence of an exception of equipment to be detected;
the equipment failure mode predetermination and residual life prediction coupling module is used for determining the failure mode and predicting the residual life according to the time of occurrence of the exception, and transmitting the failure mode and the residual life to the equipment maintenance decision-making platform;
the equipment failure mode predetermination and residual life prediction coupling system is implemented by an equipment failure mode predetermination and residual life prediction coupling method, which comprises the following steps:
S1: acquiring, by the corresponding sensors, the equipment health information of the equipment to be detected;
S2: receiving and caching the equipment health information and recognizing the time of occurrence of the exception of the equipment to be detected, by the corresponding abnormal state recognition module;
S3: according to the time of occurrence of the exception of the equipment to be detected, determining the failure mode and predicting the residual life by the equipment failure mode predetermination and residual life prediction coupling module; and
S4: transmitting the failure mode and the residual life to the equipment maintenance decision-making platform;
S3 comprises the following sub-steps:
S31: extracting, a temporal sample, of the equipment failure mode predetermination and residual life prediction coupling module;
S32: calculating, by a probabilistic graphical model, a cumulative failure occurrence probability of the temporal sample;
S33: according to the cumulative failure occurrence probability of the temporal sample, calculating an empirical distribution function of each probabilistic graphical model fragment, and taking a time and failure mode corresponding to a maximum value of the empirical distribution function as an equipment residual life predicted value and a failure mode predicted value respectively;
S34: determining, by a DKW inequation, a confidence interval of the equipment residual life predicted value, and calculating, by an edge density function, a variance of the failure mode predicted value; and
S35: taking the equipment residual life predicted value, the failure mode predicted value, the confidence interval of the equipment residual life predicted value and the variance of the failure mode predicted value as prediction results of the equipment failure mode predetermination and residual life prediction coupling module;
in S31, the temporal sample x_{pq} is expressed as x_{pq}={x_{pq}(1), . . . , x_{pq}(T_{gq}^{c}−1),x_{pq}(T_{pq}^{c})};
where, x_{pq}(1), . . . , x_{pq}(T_{gq}^{c}−1), x_{pq}(T_{pq}^{c}) denote health information fragments of T_{pq}^{c} equipment nodes q of an equipment type p periodically collected at a time Tₚ^{c};
in S32, a specific method for calculating the cumulative failure occurrence probability of the temporal sample comprises: moving rightwards, by the probabilistic graphical model, the probabilistic graphical model fragment corresponding to each element in a probabilistic graphical model set by one time slice, calculating a distance from a right end of each probabilistic graphical model fragment to a right end of the corresponding element and an accumulative occurrence probability of each failure mode until the distance from the right end of each probabilistic graphical model fragment to the right end of the corresponding element is zero, and determining the accumulative failure occurrence probability;
wherein, the probabilistic graphical model set is expressed as {Gₚ₁, Gₚ₂, . . . , G_{pK}_{ₚ}}, where Gₚ₁, Gₚ₂, . . . , G_{pK}_{ₚ} denote probabilistic graphical models corresponding to Kₚ failure modes of the equipment type p;
the accumulative occurrence probability F(lₚₖ,k|x_{pq}) of each failure mode is calculated by:
$$F ( {l}_{pk} , k \vert {x}_{pq} ) = Pr ( RUL < {l}_{pq} , k , {x}_{pq} ) / Pr ( {x}_{pq} )$$
where, lₚₖ denotes the distance from the right end of each probabilistic graphical model fragment to the right end of the corresponding element, x_{pq} denotes the temporal sample, RUL denotes the residual life, Pr(⋅) denotes a probability function, and k denotes each failure mode of the equipment type p;
in S33, the empirical distribution function Pr(RUL=lₚₖ,k|x_{pq}) of each probabilistic graphical model fragment is expressed as:
$$Pr ( RUL = {l}_{pk} , k \vert {x}_{pq} ) = F ( {l}_{pk} + 1 , k \vert {x}_{pq} ) - F ( {l}_{pk} , k \vert {x}_{pq} ) , \\ {l}_{pk} = - {T}_{p} + {T}_{p}^{c} - 1 , - {T}_{p} + {T}_{p}^{c} , … , 0$$
where, lₚₖ denotes the distance from the right end of each probabilistic graphical model fragment to the right end of the corresponding element, x_{pq} denotes the temporal sample, RUL denotes the residual life, Pr(⋅) denotes the probability function, k denotes each failure mode of the equipment type p, F(⋅) denotes the probability function, T_{P} denotes the number of time slices in the probabilistic graphical model, and Tₚ^{c} denotes a periodical extraction time.

2. An equipment failure mode predetermination and residual life prediction coupling method, comprising the following steps:
S1: acquiring, by sensors, equipment health information of equipment to be detected;
S2: receiving and caching the equipment health information and recognizing a time of occurrence of an exception of the equipment to be detected, by an abnormal state recognition module;
S3: according to the time of occurrence of the exception of the equipment to be detected, determining a failure mode and predicting a residual life by an equipment failure mode predetermination and residual life prediction coupling module; and
S4: transmitting the failure mode and the residual life to an equipment maintenance decision-making platform;
S3 comprises the following sub-steps:
S31: extracting, a temporal sample, of the equipment failure mode predetermination and residual life prediction coupling module;
S32: calculating, by a probabilistic graphical model, a cumulative failure occurrence probability of the temporal sample;
S33: according to the cumulative failure occurrence probability of the temporal sample, calculating an empirical distribution function of each probabilistic graphical model fragment, and taking a time and failure mode corresponding to a maximum value of the empirical distribution function as an equipment residual life predicted value and a failure mode predicted value respectively;
S34: determining, by a DKW inequation, a confidence interval of the equipment residual life predicted value, and calculating, by an edge density function, a variance of the failure mode predicted value; and
S35: taking the equipment residual life predicted value, the failure mode predicted value, the confidence interval of the equipment residual life predicted value and the variance of the failure mode predicted value as prediction results of the equipment failure mode predetermination and residual life prediction coupling module;
in S31, the temporal sample x_{pq} is expressed as x_{pq}={x_{pq}(1), . . . , x_{pq}(T_{pq}^{c}−1), x_{pq}(T_{pq}^{c})};
where, x_{pq}(1), . . . , x_{pq}(T_{pq}^{c}−1), x_{pq}(T_{pq}^{c}) denote health information fragments of T_{pq}^{c} equipment nodes q of an equipment type p periodically collected at a time Tₚ^{c};
in S32, a specific method for calculating the cumulative failure occurrence probability of the temporal sample comprises: moving rightwards, by the probabilistic graphical model, the probabilistic graphical model fragment corresponding to each element in a probabilistic graphical model set by one time slice, calculating a distance from a right end of each probabilistic graphical model fragment to a right end of the corresponding element and an accumulative occurrence probability of each failure mode until the distances from the right end of each probabilistic graphical model fragment to the right end of the corresponding element is zero, and determining the accumulative failure occurrence probability;
wherein, the probabilistic graphical model set is expressed as {Gₚ₁, Gₚ₂, . . . , G_{pK}_{ₚ}}, where Gₚ₁, Gₚ₂, . . . , G_{pK}_{ₚ} denote probabilistic graphical models corresponding to Kₚ failure modes of the equipment type p;
the accumulative occurrence probability F(lₚₖ,k|x_{pq}) of each failure mode is calculated by:
$$F ( {l}_{pk} , k \vert {x}_{pq} ) = Pr ( RUL < {l}_{pk} , k , {x}_{pq} ) / Pr ( {x}_{pq} )$$
where, lₚₖ denotes the distance from the right end of each probabilistic graphical model fragment to the right end of the corresponding element, x_{pq} denotes the temporal sample, RUL denotes the residual life, Pr(⋅) denotes a probability function, and k denotes each failure mode of the equipment type p;
in S33, the empirical distribution function Pr(RUL=lₚₖ,k|x_{pq}) of each probabilistic graphical model fragment is expressed as:
$$Pr ( RUL = {l}_{pk} , k \vert {x}_{pq} ) = F ( {l}_{pk} + 1 , k \vert {x}_{pq} ) - F ( {l}_{pk} , k \vert {x}_{pq} ) , \\ {l}_{pk} = - {T}_{p} + {T}_{p}^{c} - 1 , - {T}_{p} + {T}_{p}^{c} , … , 0$$
where, lₚₖ denotes the distance from the right end of each probabilistic graphical model fragment to the right end of the corresponding element, x_{pq} denotes the temporal sample, RUL denotes the residual life, Pr(⋅) denotes the probability function, k denotes each failure mode of the equipment type p, F(⋅) denotes the probability function, T_{P} denotes the number of time slices in the probabilistic graphical model, and Tₚ^{c} denotes a periodical extraction time.

3. The equipment failure mode predetermination and residual life prediction coupling method according to claim 2, wherein in S1, equipment health information at a time t comprises equipment operation environment information and equipment operation state information;
wherein, the equipment health information x(t) at the time t is expressed as x(t)={A₁(t), A₂(t), . . . , Aᵥ_{ₚ}(t), B₁(t), B₂(t), . . . , Bᵤ_{ₚ}(t)}, the equipment operation environment information at the time t is expressed as {A₁(t), A₂(t), . . . Aᵥ_{ₚ}(t)}, and the equipment operation state information at the time t is expressed as {B₁(t), B₂(t), . . . , Bᵤ_{ₚ}(t)};
where, vₚ denotes the number of monitored operation environment variables corresponding to the equipment type p, uₚ denotes the number of monitored operation state variables of the equipment type p, A₁(t), A₂(t), . . . Aᵥ_{ₚ}(t) denote operation environment variables corresponding to each equipment type monitored at the time t, and B₁(t), B₂(t), . . . , Bᵤ_{ₚ}(t) denote operation states variables corresponding to each equipment type monitored at the time t.

4. The equipment failure mode predetermination and residual life prediction coupling method according to claim 2, wherein S2 comprises the following sub-steps:
S21: receiving and catching, by the abnormal state recognition module, equipment health information at a time t;
S22: according to the equipment health information at the time t, predicting, by an ARIMA prediction model, predictive equipment health information at a time t+1 and prediction intervals; and
S23: according to the predictive equipment health information at the time t+1 and the prediction intervals, determining the time of occurrence of the exception.

5. The equipment failure mode predetermination and residual life prediction coupling method according to claim 4, wherein in S22, the predictive equipment health information \hat{x}(t+1) at the time t+1 is expressed as \hat{x}(t+1)={Â₁(t+1), Â₂(t+1), . . . , Âᵥ_{ₚ}(t+1), \hat{B}₁(t+1), \hat{B}₂(t+1), . . . , \hat{B}ᵤ_{ₚ}(t+1)}, a prediction interval of equipment operation environment information is expressed as [Âᵥ^{L}(t+1), Âᵥ^{U}(t+1)], v∈{1, 2, . . . , vₚ], and a prediction interval of equipment operation state information is expressed as [\hat{B}ᵤ_{_{L}}(t+1), \hat{B}ᵤ_{_{U}}(t+1)], u∈{1, 2, . . . , uₚ];
where, Â₁(t+1), Â₂(t+1), . . . , Âᵥ_{ₚ}(t+1) denote predicted values of operation environment variables corresponding to each equipment type monitored at the time t+1, \hat{B}₁(t+1), \hat{B}₂(t+1), . . . , \hat{B}ᵤ_{ₚ}(t+1) denote predicted values of operation state variables corresponding to each equipment type monitored at the time t+1, Âᵥ_{_{L}}(t+1) denotes a lower limit of a prediction interval of a v^{th} operation environment variable corresponding to each equipment type monitored at the time t+1, Âᵥ_{_{U}}(t+1) denotes an upper limit of the prediction interval of the v^{th} operation environment variable corresponding to each equipment type monitored at the time t+1, \hat{B}ᵤ_{_{L}}(t+1) denotes a lower limit of a prediction interval of a u^{th} operation state variable corresponding to each equipment type monitored at the time t+1, \hat{B}ᵤ_{_{U}}(t+1) denotes an upper limit of the prediction interval of the u^{th} operation state variable corresponding to each equipment type monitored at the time t+1, uₚ denotes the number of monitored operation state variables of an equipment type p, L denotes a preset lower warning limit, and U denotes a preset upper warning limit.

6. The equipment failure mode predetermination and residual life prediction coupling method according to claim 4, wherein in S23, if Aᵥ(t+1) is not within a prediction interval [Âᵥ^{L}(t+1), Âᵥ^{U}(t+1)] of the equipment operation environment information, an equipment operation environment at the time t+1 is abnormal;
if Bᵤ(t+1) is not within a prediction interval [\hat{B}ᵤ^{L}(t+1), \hat{B}ᵤ^{U}(t+1)] of the equipment operation state information, an equipment operation state at the time t+1 is abnormal;
where, Aᵥ(t+1) denotes an actual observed value of a v^{th} operation environment variable corresponding to each equipment type monitored at the time t+1, Bᵤ(t+1) an actual observed value of a u^{th} operation state variable corresponding to each equipment type monitored at the time t+1, Âᵥ^{L}(t+1) denotes a lower limit of a prediction interval of the v^{th} operation environment variable corresponding to each equipment type monitored at the time t+1, Âᵥ^{U}(t+1) denotes an upper limit of the prediction interval of the v^{th} operation environment variable corresponding to each equipment type monitored at the time t+1, \hat{B}ᵤ^{L}(t+1) denotes a lower limit of a prediction interval of the u^{th} operation state variable corresponding to each equipment type monitored at the time t+1, and \hat{B}ᵤ^{U}(t+1) denotes an upper limit of the prediction interval of the u^{th} operation state variable corresponding to each equipment type monitored at the time t+1.
